(19) United States
(12) Patent Application Publication
(10) Pub. No.: US 2017/0368745 A1
(43) Pub. Date: Dec. 28, 2017

(54) 3D PRINTING PROCESS AUGMENTATION BY APPLIED ENERGY

(71) Applicant: BOSTON SCIENTIFIC SCIMED, INC., Maple Grove, MA (US)

(72) Inventors: Alex ROBERTS, Allston, MA (US); Todd Robida, Sherborn, MA (US)

(21) Appl. No.: 15/616,481

(22) Filed: Jun. 7, 2017

Related U.S. Application Data
(60) Provisional application No. 62/355,183, filed on Jun. 27, 2016.

(51) Int. Cl. B29C 64/153; B33Y 80/00; B22F 3/00; B33Y 10/00; H05B 6/80; B33Y 70/00; H05B 6/10; B29K 105/00; B29K 101/12

(52) U.S. Cl. CPC B29C 64/153; B33Y 70/00; B33Y 80/00; B22F 3/008; H05B 6/101; B33Y 10/00; H05B 6/80; B29K 2101/12; B29K 2995/0008; B29K 2995/0056; B29K 2105/251

(57) ABSTRACT

A method for three-dimensional printing includes printing a three-dimensional part formed form a first material, the first material including induction sensitive particles and applying magnetic induction to the three-dimensional part during or after printing to heat the induction sensitive particles and melt the first material, allowing reflow thereof. The method also includes printing a support structure. The support structure may also include induction sensitive particles.

### PRIORITY CLAIM

The application claims priority to U.S. Provisional Patent Application Ser. No. 62/355,183 filed Jun. 27, 2016; the disclosure of which is incorporated herewith by reference.

### BACKGROUND

The present disclosure is directed to additive manufacturing techniques for printing three-dimensional (3D) parts. In additive manufacturing processes, layers of material are deposited and bonded together (optionally onto an object or a substrate) according to a prescribe pattern or design to create a 3D object. A 3D printer implements this printing process by depositing layers of material in the form of a liquid, a powder, an extrusion (e.g. a wire) or a sheet so that each layer of material fuses to previously deposited modeling material. The part material is deposited via a print head incrementally along the x-y plane and then along a z-axis (perpendicular to the x-y plane) to form a 3D part.

Movement of the print head with respect to the substrate is performed under computer control, in accordance with build data that represents the 3D part. The build data is obtained by initially slicing a digital representation of the 3D part into multiple horizontally sliced layers. Then, for each sliced layer, the host computer generates a tool path for depositing the part material to print the 3D part.

In fabricating 3D parts by depositing of layers of part material, support layers or structures are typically built underneath overhanging portions or in cavities of objects under construction, which are not supported by the part material itself. A support structure may be built utilizing the same deposition techniques by which the part material is deposited. The host computer generates additional geometry acting as a support structure for the overhanging or free-space segments of the 3D part being formed. Support material is then deposited from a second print head pursuant to the generated geometry during the build process. The support material adheres to the part material during fabrication and is removable from the completed 3D part when the build process is complete.

Existing 3D printing processes, such as fused deposition modeling (FDM) have several drawbacks. For example, most forms of 3D printing using thermoplastics have inherent porosity and surface roughness, leading to concerns in the medical field regarding bioburden.

### SUMMARY

The present disclosure is directed to a method for three-dimensional printing comprising printing a three-dimensional part formed from a first material, the first material including energy sensitive particles and applying energy to the three-dimensional part during or after printing to heat the energy sensitive particles and melt the first material, allowing reflow thereof.

In an embodiment, the energy sensitive particles are one of magnetic induction or microwave radiation sensitive particles.

In an embodiment, the method may further comprise printing a support structure configured to restrain the three-dimensional part in a first configuration, the support structure formed from a second material.

In an embodiment, the method may further comprise removing the support structure from the three-dimensional part so that the three-dimensional part deforms to a second configuration.

In an embodiment, the second material includes energy sensitive particles

In an embodiment, the method further comprises applying energy to the support structure during or after printing to heat the energy sensitive particles and melt the second material away from the three-dimensional part.

In an embodiment, the energy sensitive particles are formed of a biocompatible material.

In an embodiment, the first material is a thermoplastic.

In an embodiment, the three-dimensional part is printed using a layer-based additive manufacturing technique.

The present disclosure is also directed to a method for three-dimensional printing comprising printing a three-dimensional part formed from a first material, printing a support structure formed from a second material, the second material including energy sensitive particles, wherein the support structure is attached to the three-dimensional part, and applying energy to the support structure during or after printing to heat the energy sensitive particles and melt the second material, wherein melting of the second material detaches the support structure from the three-dimensional part.

In an embodiment, the energy sensitive particles are formed of a biocompatible metal.

In an embodiment, the three-dimensional part is printed using a layer-based additive manufacturing technique.

In an embodiment, the first and second materials are thermoplastics.

The present disclosure is also directed to an object printed with a three-dimensional printing system, the object comprising a support structure formed of a first material, and a three-dimensional part coupled to the support structure, the part being formed from a second material including energy sensitive particles, wherein application of energy to the three-dimensional part causes the energy sensitive particles to melt the second material, allowing reflow thereof.

### BRIEF DESCRIPTION

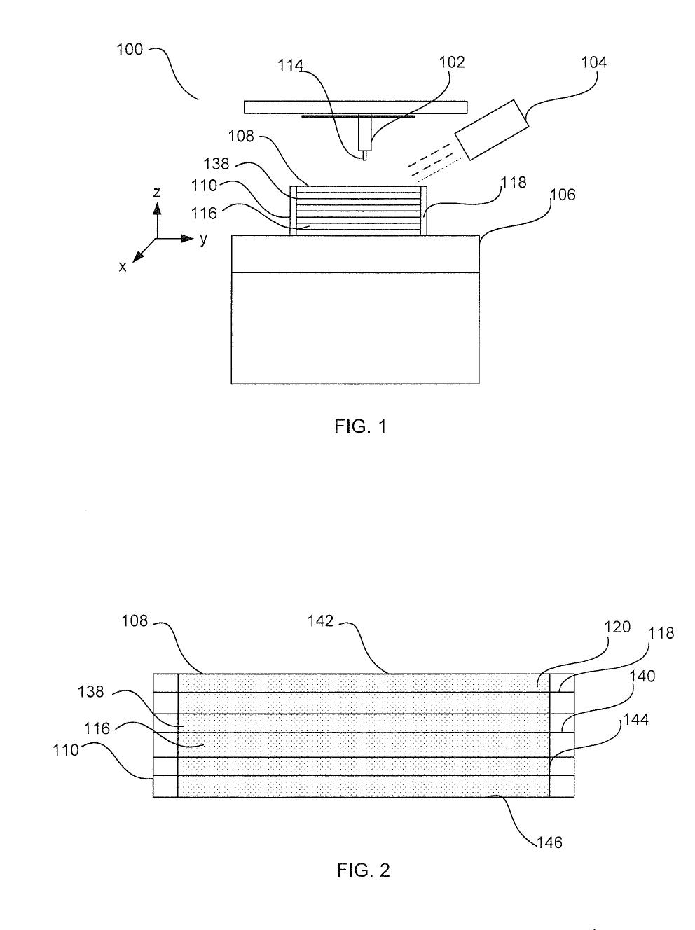

FIG. 1 shows a side view of a system according to a first exemplary embodiment of the disclosure;

FIG. 2 shows a side view of a 3D part and support structure of the system of FIG. 1;

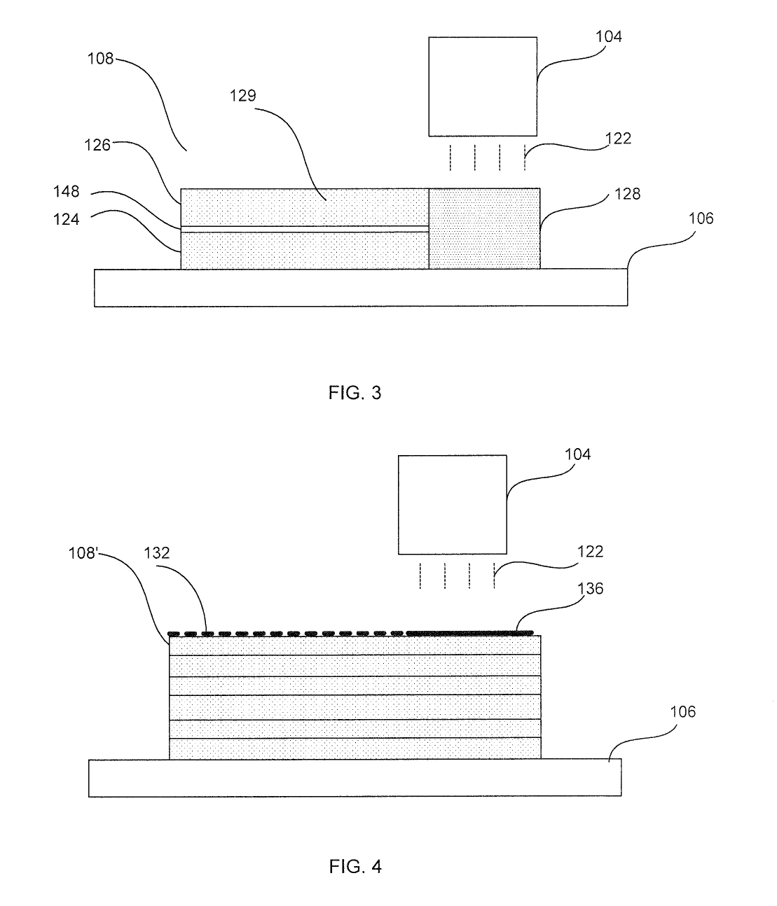

FIG. 3 shows another side view of the system of FIG. 1 during application of magnetic induction or microwave radiation;

FIG. 4 shows another side view of the system of FIG. 1 during application of magnetic induction or microwave radiation;

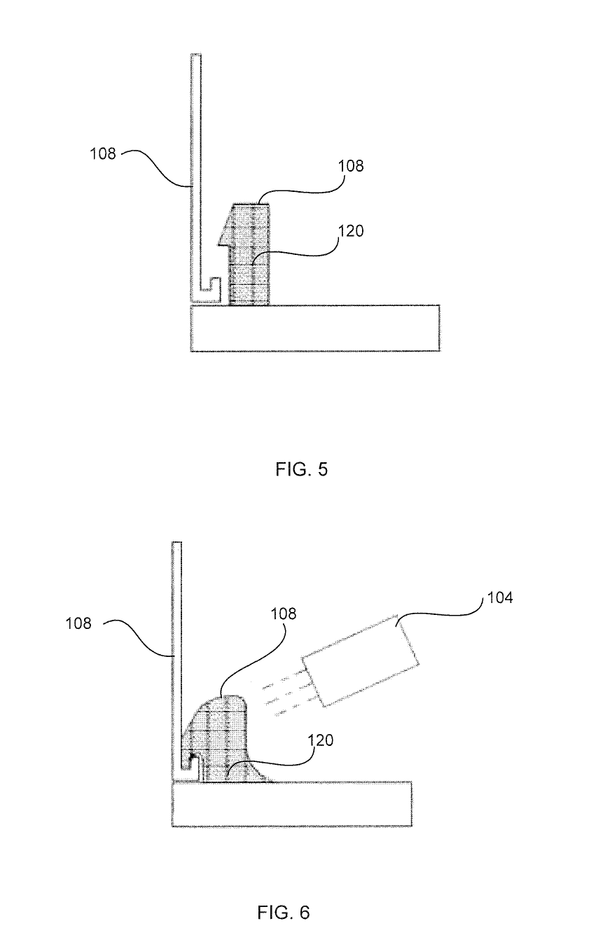

FIG. 5 shows another side view of the system of FIG. 1 using multiple deformable 3D parts;

FIG. 6 shows another side view demonstrating the energy application process to the 3D parts of FIG. 5;

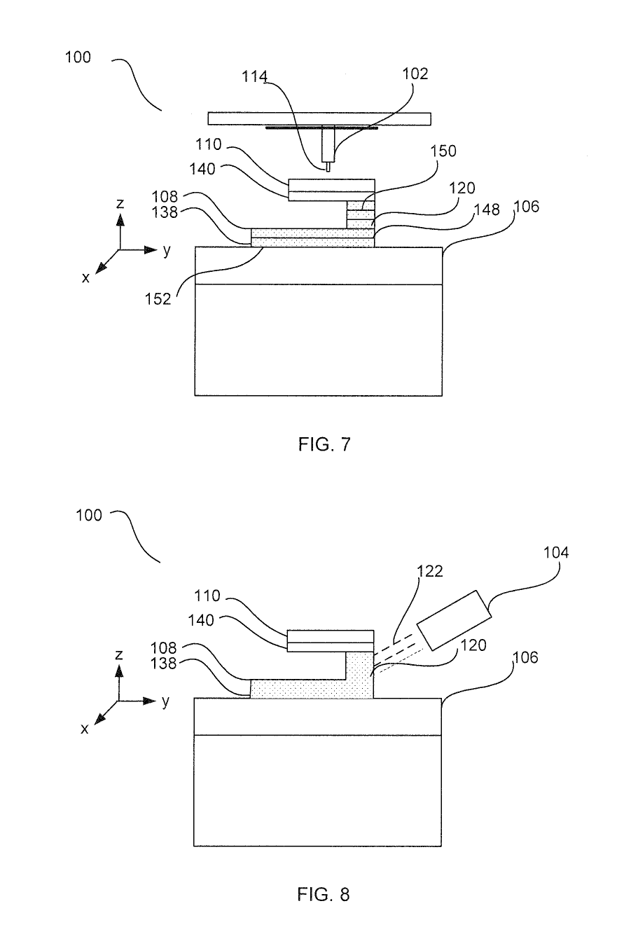

FIG. 7 shows another side view of the system of FIG. 1 demonstrating the printing process of 3D part and support structure;

FIG. 8 shows another side view demonstrating the energy application process of 3D part and support structure of FIG. 7;

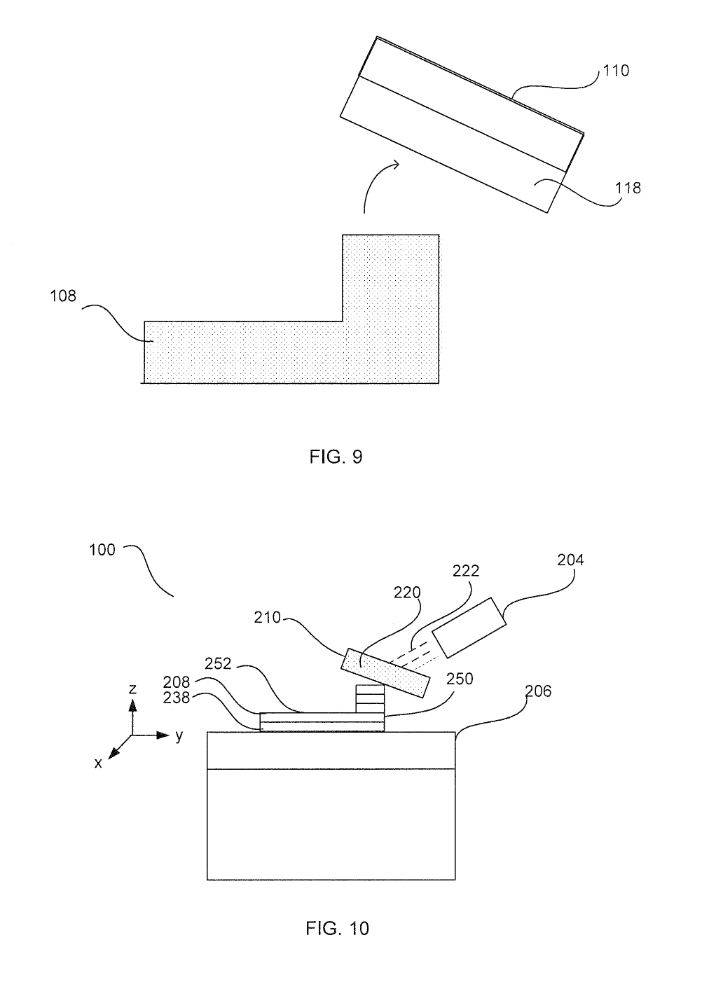

FIG. 9 shows a side view of the 3D part and support structure of FIGS. 7-8 demonstrating the removal of the support structure from the 3D part;

FIG. 10 shows another side view of the system of FIG. 1 demonstrating the energy application process of 3D part and support structure according to another exemplary embodiment of the present disclosure; and

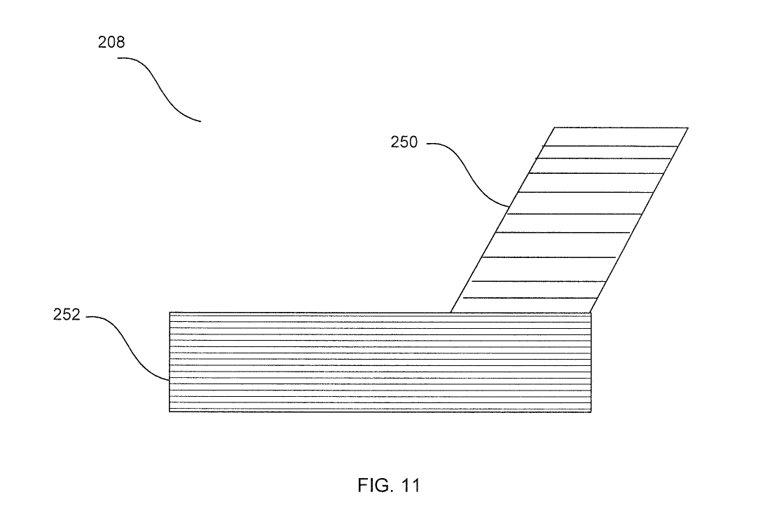

FIG. 11 shows a side view of another exemplary 3D part and support structure of the system of FIG. 1 demonstrating the removal of the support structure from the 3D part.

### DETAILED DESCRIPTION

The present disclosure may be further understood with reference to the following description and the appended drawings, wherein like elements are referred to with the same reference numerals. The present disclosure is directed to a process for printing a 3D part and/or a support structure. Exemplary embodiments of the present disclosure describe a process for printing a 3D part/support structure using a material that includes the addition of energy sensitive materials. The process also involves an energy application cycle using microwave/induction energy, in which the 3D part and/or support structure are heated to melt one or both of the parts.

The present disclosure is directed to the incorporation into 3D print materials of energy sensitive materials, such as materials that absorb microwave energy or magnetic or electric energy through induction. These energy sensitive materials may be incorporated into all or part of a printed 3D object (e.g., in particulate form) to impart properties to the materials that can be used to achieve structural qualities as described in more detail below. In particular, a 3D object may be printed with a single material including energy sensitive particles or it may be printed with a combination of materials, some parts of the object including energy sensitive materials while others are without these materials. Application of energy, such as microwave radiation or magnetic induction energy, to material including these energy sensitive materials causes these materials to heat up or to enhance this heating up as compared to materials not including these energy sensitive materials. In the context of 3D printing, induced heating of materials including energy sensitive particles upon energy application during or after printing may be used to facilitate softening or melting of portions or all of the 3D part to, for example, make the object pliable so that its shape may be changed as desired, to smooth surfaces, or to facilitate the removal of structures included, for example, solely to support parts of the printed 3D object during the printing process. Energy can be applied at varying powers, frequencies, and exposure durations depending on the desired application and substance used. For example, more power and longer duration both result in more heat application. Frequency may also be tuned to be more or less effective for given materials and energy sensitive particle sizes. For example, a 3D object may include energy sensitive material distributed uniformly throughout the object. In this example, application of energy to the printed object heats the energy sensitive material to facilitate softening of the print material throughout the printed 3D object promoting redistribution/reflow of the material, reducing porosity of the entire object. This redistribution/reflow of the material of which the 3D printed object is formed may create a smoother surface of the 3D object. In another example, a 3D object may include energy sensitive material only in one or more portions of the 3D object. In this example, application of a first level of energy to the printed object may facilitate softening of these selected portions of the 3D object. However, upon application of a higher amount of energy, the parts of the 3D printed object including the energy sensitive particles may induce enhanced melting of the material to fill in spaces which the 3D printer was unable to print—i.e. difficult geometries or to secure together multiple separate parts intended to be fit securely together. In a further example, the 3D object may include a support structure printed from energy sensitive material. In this example, energy may be applied to melt away the support structure permitting its removal from the 3D object after printing has been completed.

As shown in FIG. 1, a system 100 according to a first exemplary embodiment of the present disclosure is an additive manufacture system for building 3D parts and support structures pursuant to the process of the present disclosure. In a preferred embodiment, the system 100 is a fused depositing modeling (FDM) system. However, any other additive manufacturing system may be used, as would be understood by those skilled in the art. The system 100 includes a print head 102 and an energy emitter 104 which emits energy such as, for example, magnetic induction or microwave radiation energy. As would be understood in the art, the energy emitter 104 may be housed within the 3D printer or may be separate from the 3D printer. The system 100 further includes a platform 106 for printing a 3D part 108 and, if necessary, a corresponding support structure 110.

The 3D part 108 may be built on the platform 106. The print head 102 prints the 3D part 108 on the platform 106 in a layer-by-layer manner, based on a preconceived design data provided from a controller (not shown). The print head 102 is configured to move in a horizontal x-y plane relative to the platform 106 based on signals provided from a controller (not shown). The x-y plane is a plane defined by an x-axis and a y-axis, where the x-axis and the y-axis are parallel to a vertical z-axis. In an embodiment, the platform 106 may move along the z-axis such that layers 138 of material may be printed on the platform 106. In another embodiment, the platform 106 may move in the x-y plane while the print head 102 moves along the z-axis. Other similar configurations may also be used such that one or both of the platform 106 and the print head 102 are movable relative to one another. If a support structure 110 is necessary, the support structure 110 may also be built on the platform 106 in the same manner as the 3D part 108. As described above, the print head 102 prints the support structure 110 on the platform 106 in a layer-by-layer manner, based on the preconceived design data provided from the controller (not shown).

In a preferred embodiment, the 3D part 108 and the support structure 110 may be printed from a single print head 102. The print head 102 may, for example, have a single-tip extrusion head 114 configured to deposit both part material 116 and support structure material 118. In another embodiment, the print head 102 may have a dual-tip extrusion head 114 with a first tip configured to deposit part material 116 and a second tip configured to separately deposit support material 118. In a further embodiment, the system 100 may include a plurality of print heads 114 for depositing part material 116 and/or support material 118 from one or more tips.

The part material 116 and the support material 118 may be provided to the system 100 in a variety of different forms. In a preferred embodiment, the materials 116, 118 may be supplied to the print head 102 in the form of continuous filaments. For example, in the system 100, the part and support materials 116, 118 may be provided as continuous filament strands fed to the print head 102. In another embodiment, the material fed to the print head 102 may be a powder. In a further embodiment, the material may be granulated.

In an exemplary embodiment, the 3D part 108 is printed from a part material 116 that compositionally includes a polymer having energy sensitive materials 120 such as microwave or induction sensitive materials in a powder, granular or filament form. Examples of suitable part materials 116 include thermoplastic materials such as, for example, Acrylonitrile Butadiene Styrene (ABS), Acrylonitrile Styrene Acrylate (ASA), Nylon, Ultem and Polycarbonate. Energy sensitive materials 120 incorporated into the part material 116 may be formed of a biocompatible metal such as, for example, stainless steel, titanium, nickel and Nitinol. The energy sensitive materials 120 may also be any conductor with resistance. Energy sensitive materials may also be any molecule with a dipole moment as such molecules can be microwave heated. In an exemplary embodiment, the energy sensitive materials 120 are incorporated into the part material 116 homogeneously to allow for uniform behavior. In this embodiment, the support structure 110 may also be printed from a material similar to that of which the 3D part 108 is formed, such as, for example, thermoplastic materials. However, in this embodiment the support material 118 does not include energy sensitive materials 120, as can be seen in FIG. 2. In another embodiment, the support material 118 also includes energy sensitive materials 120 incorporated therein and, in a further embodiment, the support material 118 may include energy sensitive materials 120 while the part material 116 does not. The energy sensitive materials 120 may also be formed of a biocompatible metal such as, for example, iron or copper. In this embodiment, the support material 118 may be the same as the 3D part material 116 or may include a different energy sensitive material 120 than the 3D part material 116. In yet another embodiment, the support material 118 may include energy sensitive material 120 while 3D part material 116 does not include any energy sensitive material 120.

The received part and support materials 116, 118 are deposited by the print head 102 onto the platform 106 to print the 3D part 108 in coordination with the printing of the support structure 110 using a layer-based additive manufacturing technique, as described above. As shown in FIG. 2, the 3D part 108 is printed as a series of successive layers 138 of the part material 116 and the support structure 110 is printed as a series of successive layers 140 of the support material 118 in coordination with the printing of the 3D part 108.

The energy emitter 104 applies energy 122 such as microwave radiation or magnetic induction energy to the 3D part 108 and/or the support structure 110 to heat the energy sensitive particles 120 within the 3D part 108 and/or the support structure 110 until the material of either part reaches a transition temperature and softens or melts. The temperature required to melt a material may vary depending on the desired level of melt and the plastic being used. For example, the softening temperature (Tg) of ABS is 116° C. while full melt occurs at 224° C. In other examples, Nylon 12 Tg ranges from 41-170° C. with a melt temperature of between 130-200° C. (depending on grade) and Polycarbonate Tg occurs at 145-150° C. with full melt between 250-343° C. In a first embodiment, the energy 122 may be applied after the 3D part 108 and the support structure 110 have been printed. In a second embodiment, at least a portion of the energy application may be performed while the 3D part 108 and the support structure 110 are being printed, for example, by a heating mechanism within the print head 102. As discussed below, this energy application enhances interlayer bonding, increases part strength and reduces porosity.

FIG. 2 shows an example of a simple 3D part 108 having a top surface 142, lateral surfaces 144 and a bottom surface 146. The support structure 110 is desirably deposited on two opposing lateral surfaces 144. It will be understood that the system 100 may print 3D parts 108 having a variety of different geometries. The system 100 may also print corresponding support structures 110 that restrain, support, or encapsulate the 3D parts 108, such as at the surfaces of the 3D parts 108. Additionally, the support structures 110 may provide vertical support along the z-axis for any overhanging regions of the layers of the 3D parts 108, allowing the 3D parts 108 to be built with a variety of geometries.

FIG. 3 illustrates a printed 3D part 108 undergoing modification through exposure to applied energy (e.g. microwave radiation or magnetic induction) 122. FIG. 3 shows the printed 3D part 108 in the process of undergoing reflow upon exposure to energy 122. Referring to FIG. 3, the 3D part 108 is present upon platform 106 and was previously formed during the printing process and contains a lower layer 124 and an upper layer 126. As can be seen, spaces 148 between strands in the layers make the 3D part 108 a porous build. Upon applying energy 122 from the energy emitter 104 across a portion of the 3D part 108, melting and reflow of the lower layer 124 and the upper layer 126 can be achieved in a consolidated (i.e. denser) region 128, providing greater structural integrity to the 3D part 108. The remaining nonconsolidated portion 129 of the lower layer 124 and upper layer 126 can similarly be melted and reflowed as desired by applying energy 122 from energy emitter 104 to cause complete consolidation of the 3D part 108.

FIG. 4 similarly shows how a printed 3D part 108′ can undergo surface smoothing upon exposure to energy 122 from the energy emitter 104. As shown in FIG. 4, as-deposited, the 3D part 108′ initially has roughened surface 132 on outer layer 134 thereof. By applying energy 122 from the energy emitter 104 to the roughened surface 132, energy sensitive particle 120 allow the material to reflow to form a smooth surface 136. By continuing to apply energy 122 from the energy emitter 104 across 3D part 108′, extension of the smoothed surface 136 can be realized.

In some cases, 3D printed pieces and reflow may be part of secondary processes such as insert molding or blow molding. In such cases, thermoplastics used in printing of a 3D part 108 may be difficult to mold into specific geometries. In an exemplary embodiment, 3D part 108 may be printed in a form similar to the final desired form and placed in a ceramic mold. Energy emitter 104 is then focused on the 3D part so that the 3D part becomes more plastic and pressure is applied to allow the 3D part material to flow into the desired shape within the mold. In another exemplary embodiment, more complex geometries may be achieved by having the print head 102 print a majority of the 3D part material 116, including energy sensitive particles 120, where needed and then applying energy 122. The energy emitter 104 may be focused on a specific location or the entire 3D part 108 to promote softening, melting and/or reflow of all or specific portions of the 3D part 108 to achieve geometries that could not be achieved by the print head 102 itself.

In another exemplary embodiment illustrated in FIGS. 5-6, a combination of model materials, energy sensitive and inert, may be used together to create multiple deformable 3D parts 108. In this embodiment, the print head 102 may print multiple 3D parts 108 that may then be attached to one another or to other pieces freely in their undeformed states. In an alternate exemplary embodiment, a single 3D part may be printed and coupled to a non-printed part, such as an element formed using injection molding. The energy emitter 104 may then be focused on the multiple 3D parts 108 to melt the energy sensitive materials 120, causing them to deform or melt into place, creating a secure fit between the multiple 3D parts 108.

FIGS. 7-9 illustrate an exemplary method of the present disclosure for printing and energy application of the 3D part 108 including energy sensitive particles 120 and the support structure 110 without energy sensitive particles with the system 100. While the method is described herein with reference to the 3D part 108 and the support structure 110, the method may also be used for printing and energy application to 3D parts and support structures having a variety of geometries. As shown in FIG. 7, the 3D part 108 is printed in a series of layers 138 to define the geometry of the 3D part 108 having a vertical portion 150 and a lateral portion 152.

The support structure 110 is also printed in a series of layers 140 in coordination with the printing of the layers 138 of the 3D part 108, where the printed layers 140 of the support structure 110 are structured to apply tension to the vertical portion 150 to restrain the vertical portion 150 of the 3D part 108 in a specific geometry. For example, in FIG. 7, the restraining support structure 110 is printed at a free end of the vertical portion 150 to hold the vertical portion 150 in a desired position to facilitate printing. It is noted that in the present embodiment, the printed layers of the 3D part and the support structure 138,140 have substantially the same layer thickness. In an alternate embodiment, the layers 140 of the support structure 110 may differ in thickness from the 3D part layers 138. As noted above, the support structure 110 may be printed at the same time as the 3D part 108 via the same print head 102 or a different print head 102. In another embodiment, the support structure 110 may be printed after the 3D part 108 via the same print head 102 or a different print head 102.

After the print operation has been completed, the 3D part 108 and the support structure 110 may then undergo an energy application cycle, as shown in FIG. 8. As discussed below, this cycle involves applying energy 122 to the parts 108, 110 to increase the temperature of the 3D part 108 and/or support structure 110 via the energy sensitive particles 120. As shown in FIG. 8, the application of energy 122 causes the temperature of the energy sensitive particles 120 in the 3D part 108 to increase, causing the materials of the layers 138 to soften and/or melt and flow throughout or along the part 108 to eliminate surface roughness, spaces 148 and porosity within the layers, and to increase strength of the 3D part 108. In this instance, the input of energy 122 to the 3D part 108 and the support structure 110 does not cause the support structure 110 to melt since parts lacking the energy sensitive particles 120 will not undergo effective heating. Thus, support structure 110 is shown with original printed layers 140 while 3D part layers 138 have been melted together.

After the energy application cycle has been completed, the resulting 3D part 108 and/or support structure 110 may be removed from the energy emitter 104 and the support structure 110 may be removed from the 3D part 108, as shown in FIG. 9. For example, the support structure 110 may be removed by snapping or breaking it away from the 3D part 108. In another example, the support material 118 may be partially soluble in water such that the resulting 3D part 108 and support structure 110 may be immersed in water to dissolve the support structure 110 for removal from the 3D part 108. It is understood that the support structure 110 may be removed from the 3D part 108 by any other method known in art. The resulting 3D part 108 accordingly exhibits dimensions corresponding to the preconceived design.

FIGS. 10-11 illustrate another exemplary method of the present disclosure for printing and energy application of a 3D part with system 100. As shown in FIG. 10, the 3D part 208 may be printed in the same manner as discussed above for 3D part 108 with layers 238 and including a vertical portion 250 and a lateral portion 252. Similarly, the support structure 210 may be printed in the same manner as discussed above for the support structure 110 with layers 240. However, in this example, the support structure 210 is composed of a material including energy sensitive particles 220 and the 3D part 208 is composed of a material without energy sensitive particles. FIG. 10 shows 3D part 208 is printed in a first configuration with a geometry designed to solidify with sufficient internal tension to deform when released. After the print operation has been completed, the 3D part 208 and the support structure 210 undergo a similar energy application cycle, as illustrated in FIG. 10. In this embodiment, because it is the support structure 210 that includes energy sensitive particles 220, the application of energy 222 causes the layers 240 of the support structure 210 to soften and/or melt. The support structure 210 consequently melts away from the 3D part 208 which does not undergo effective heating due to the lack of energy sensitive particles 220 therein. As can be seen in FIG. 11, because the support structure 210 no longer restrains the 3D part 208 in the printed configuration, the tension within the vertical portion 250 is released and the 3D part 208 is able to deform from the first configuration to a desired second configuration.

It will be apparent to those skilled in the art that various modifications may be made in the present disclosure, without departing from the scope of the disclosure. Thus, it is intended that the present disclosure cover modifications and variations of this disclosure provided that they come within the scope of the appended claims and their equivalents.

1-15. (canceled)

16. A method for three-dimensional printing, comprising:
printing a three-dimensional part, the part being formed from a first material including energy sensitive particles; and
applying energy to the three-dimensional part during or after printing to heat the energy sensitive particles and soften the printing material, allowing reflow thereof.

17. The method of claim 16, wherein the energy sensitive particles are one of magnetic induction or microwave radiation sensitive particles.

18. The method of claim 16, further comprising printing a support structure configured to restrain the three-dimensional part in a first configuration, the support structure formed from a second material.

19. The method of claim 16, further comprising removing the support structure from the three-dimensional part so that the three-dimensional part deforms to a second configuration.

20. The method of claim 16, wherein the second material includes energy sensitive particles.

21. The method of claim 16, further comprising applying energy to the support structure during or after printing to heat the energy sensitive particles and melt the support material away from the three-dimensional part.

22. The method of claim 16, wherein the energy sensitive particles are formed of a biocompatible metal.

23. The method of claim 16, wherein the printing material is a thermoplastic.

24. The method of claim 16, wherein the three-dimensional part is printed using a layer-based additive manufacturing technique.

25. A three-dimensional printing process, comprising:
printing a three-dimensional part formed from a first material;
printing a support structure formed from a second material, the second material including energy sensitive particles, wherein the support structure is attached to the three-dimensional part; and
applying energy to the support structure during or after printing to heat the energy sensitive particles and melt the second material, wherein melting of the second material detaches the support structure from the three-dimensional part.

26. The method of claim 25, wherein the energy sensitive particles are one of magnetic induction or microwave radiation sensitive particles.

27. The method of claim 25, wherein the energy sensitive particles are formed of a biocompatible metal.

28. The method of claim 25, wherein the three-dimensional part is printed using a layer-based additive manufacturing technique.

29. The method of claim 25, wherein the first and second materials are thermoplastics.

30. The method of claim 25, wherein the first material is different from the second material.

31. An object printed with a three-dimensional printing system, the object comprising:
a support structure formed of a first material;
a three-dimensional part coupled to the support structure, the part being formed from a second material including energy sensitive particles;
wherein application of energy to the three-dimensional part causes the energy sensitive particles to soften the second material, allowing reflow thereof

32. The object of claim 31, wherein the energy sensitive particles are one of magnetic induction or microwave radiation sensitive particles.

33. The object of claim 31, wherein the energy sensitive particles are formed of a biocompatible metal.

34. The object of claim 31, wherein the first material includes energy sensitive particles.

35. The object of claim 31, wherein the support structure and the three-dimensional part are printed using a layer-based additive manufacturing technique.
